(19) United States
(12) Patent Application Publication
(10) Pub. No.: US 2005/0261853 A1
(43) Pub. Date: Nov. 24, 2005

(54) Method and apparatus for detecting multiple signal anomalies

(76) Inventor: Kenneth P. Dobyns, Beaverton, OR (US)

Correspondence Address: Thomas F. Lenihan;Tektronix, Inc., P.O. Box 500, M/S 50-LAW, Beaverton, OR, 97077-0001, US

(21) Appl. No.: 10/848,797

(22) Filed: May 18, 2004

(51) Int. Cl. G06F 19/00

(52) U.S. Cl. 702/108

(57) ABSTRACT

A test and measurement instrument includes a trigger system for controlling an acquisition system to acquire digital signal samples. The trigger system is selectively responsive to a trigger circuit for detecting a trigger event associated with an input signal, and to circuitry for detecting various sequences or combinations of anomalies. Further, selected sequences and combinations of the anomalies may be combined across a plurality of channels of the test and measurement instrument, or across multiple instruments, thereby allowing more sophisticated triggering criteria to be defined.

### FIELD OF THE INVENTION

The present invention generally concerns an oscilloscope architecture providing detection of anomalous events, and more specifically concerns an oscilloscope architecture for simultaneously monitoring an input signal to detect multiple different types and combinations of anomalies.

### BACKGROUND OF THE INVENTION

In a conventional digital real time oscilloscope, an A/D converter digitizes an analog input signal, and the resulting digital signal samples are stored in memory. The analog input signal is also applied to a trigger circuit that detects a trigger event in the input signal. Storage of the digitized signal samples into memory is performed in response to the detection of a trigger event. Rasterizer circuitry then places the digital signal samples into a form suitable for display. The resultant waveform data can then be drawn on a display device such as a Liquid Crystal Display (LCD).

Well-known trigger circuits for oscilloscopes are responsive to any one of several types of anomalous events. Such anomalies include, but are not limited to, narrow pulses or glitches, pulses that are lower than expected (runt pulses), a rise time or fall time that is slower that expected, an input signal falling within or outside of a “window”, or insufficient setup and hold time of a signal with respect to a clock. Thus, an oscilloscope can be set to detect any one of these anomalous events and generate a trigger to control acquisition of digital signal samples of the input signal.

Commonly assigned U.S. Pat. No. 5,841,286 (Stoops) discloses monitoring circuitry that continuously monitors an input signal on an oscilloscope for a number of distinct anomalies in parallel. The monitoring circuitry of Stoops counts these anomalies and presents a summary of them to the user. These anomalies may be optionally routed, via an OR gate, into the oscilloscope trigger system so that they may be used to trigger a data acquisition cycle. Finally, the Stoops patent discloses how the anomaly detection circuitry from many channels can be combined, via an OR gate, and routed into the oscilloscope trigger system so that any anomalistic event on any input channel can be used to trigger a data acquisition cycle. The '286 Stoops patent is described in terms of an older analog oscilloscope. While the '286 Stoops patent works well for its intended purpose, it cannot recognize certain triggering conditions that a user of today's oscilloscopes may need.

Some limitations of existing arrangements include instances where a user might not be interested in detecting all runt signals occurring on a tri-state bus, since at least some of them are very likely to occur when the bus is not asserted. This condition cannot be distinguished from normal operation using the prior art monitoring circuitry. Another limitation is where a user wants to trigger on setup and hold violations, but only after a glitch has just been detected. In yet another limitation, a user may want to trigger on anomalous events on any of three input channels, but may want to exclude runts on one channel. In addition, the user may not be interested in triggering on any anomalous events unless a fourth channel is asserted, indicating that the device under test is active.

### SUMMARY OF THE INVENTION

A test and measurement instrument includes a trigger system for controlling an acquisition system to acquire digital signal samples. The trigger system is selectively responsive to a trigger circuit for detecting a trigger event associated with an input signal, and to circuitry for detecting various sequences or combinations of anomalies. Further, selected sequences and combinations of the anomalies may be combined across a plurality of channels of the test and measurement instrument, or across multiple instruments, thereby allowing more sophisticated triggering criteria to be defined.

### BRIEF DESCRIPTION OF THE DRAWINGS

The following drawing may be useful for understanding the invention.

FIG. 1 is a block diagram of a test and measurement instrument embodying the present invention; and

FIG. 2 is a block diagram of a trigger programmable logic circuit suitable for use with multiple channels in the test and measurement instrument of FIG. 1.

To facilitate understanding, identical reference numerals have been used, where appropriate, to designate identical elements that are common to the figures.

### DETAILED DESCRIPTION OF THE EMBODIMENTS

The present invention is discussed in the context of a signal quality monitoring circuit that may be implemented in a Test and Measurement Instrument, such as a Digital Storage Oscilloscope (DSO), a logic analyzer, or the like. Such oscilloscopes and logic analyzers are manufactured by Tektronix, Inc. of Beaverton, Oreg.

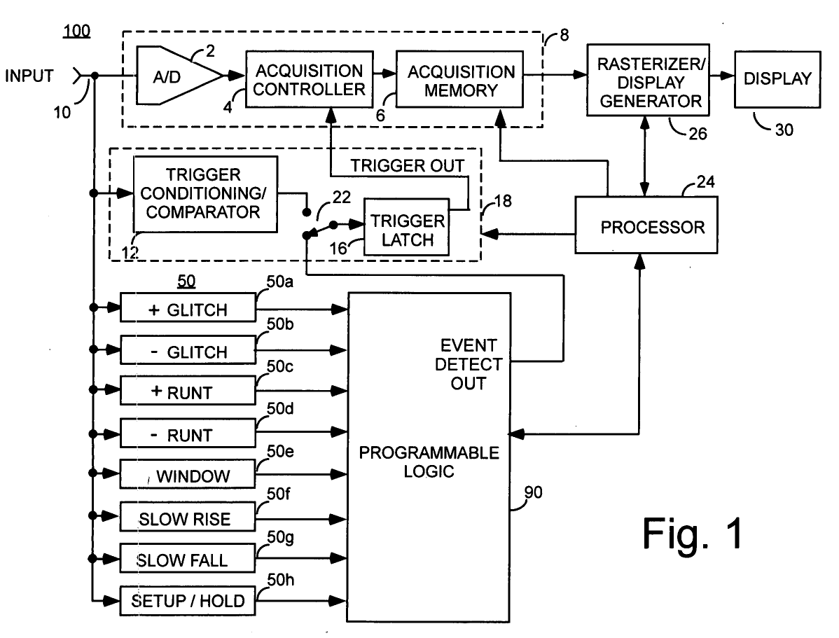

FIG. 1 is a block diagram of a Test and Measurement Instrument 100 embodying the present invention. Although Test and Measurement Instrument 100 will be discussed in terms of a digital real-time oscilloscope, the teachings of the present invention should not be considered as being limited to an oscilloscope.

Referring to FIG. 1, Oscilloscope 100 receives an input Signal Under Test (SUT) via an input terminal 10. Oscilloscope 100 comprises an Acquisition System 8, a Trigger System 18, a Processor 24, a Display Generator (including a rasterizer) 26, a Display Device 30, and Programmable Logic circuitry 90.

Acquisition System 8 comprises an A/D Converter 2, an Acquisition Controller 4, and an Acquisition Memory 6. Trigger system 18 comprises Trigger Conditioning circuitry (including a trigger comparator) 12, a Trigger Latch 16, and a Switch 22. Processor 24 may comprise one or more microprocessors or similar devices for processing data between, and controlling the operation of, the Acquisition System 8, the Trigger System 18, Display Generator 26, and Programmable Logic circuitry 90.

The SUT at input 10 is digitized by A/D Converter 2, and the resultant data samples are passed through Acquisition Controller 4, where they may be processed or decimated prior to storing them in Acquisition Memory 6. In addition, Acquisition Controller 4 determines which of the data samples will actually be stored in Acquisition Memory 6, thereby forming an acquired waveform. The SUT at input 10 is simultaneously applied to a Trigger Conditioning circuit and Trigger Comparator circuit 12, which provides an output trigger signal indicative of the conditioned input signal meeting certain criteria, such as its passing through a selected threshold level in a predetermined direction.

The trigger signal is applied through Switch 22 to Trigger Latch 16, which provides a signal to Acquisition Controller 4 for controlling the storage of the acquired waveform. Display Generator 26 then rasterizes the acquired waveform and may add additional information necessary to generate a display image that is displayed on Display Device 30. At some point, illustratively during or after the generation of this display image, Acquisition Controller 4 and Trigger Latch 16 are reset so that another acquisition cycle can begin.

As described thus far, Oscilloscope 100 operates in a conventional fashion. That is, the waveform of the input signal is ultimately displayed in response to the input signal meeting predetermined trigger criteria. The SUT at input 10 of Oscilloscope 100 is also connected to an array of Anomaly Detection circuits 50 for detecting anomalies associated with the SUT. As noted above, such anomalies associated with a SUT may include positive or negative glitches, positive or negative runts, slow rise/fall times, window excursions, insufficient setup and hold times of the signal with respect to a clock, and the like. Each of Anomaly Detectors 50a-50h continuously monitors the input signal for the occurrence of a particular respective anomaly.

The outputs of Anomaly Detectors 50a-50h are connected to respective inputs of a Programmable Logic circuit 90. The output of Programmable Logic circuitry 90 is a signal indicative of a detected occurrence of a preselected event comprising a particular combination or sequence of anomalies. For example, a user may be interested in knowing when a positive glitch is followed by signal exhibiting a slow fall time. The user may program Programmable Logic circuit 90 to detect such a sequence of anomalies, while excluding other anomalies that may occur on the signal under test.

It is important to note that apparatus according to teachings of the '286 Stoops patent would not be able to exclude certain detected anomalies from producing a trigger signal. Such apparatus may interfere with troubleshooting activities by triggering on occurrences of anomalies that are not important to the user at that time. Moreover, apparatus according to teachings of the '286 Stoops patent would not be able to detect specific sequences of anomalies for producing a desired trigger signal.

When an anomaly (or combination of anomalies, or sequence of anomalies) associated with the SUT at input 10 is detected by Programmable Logic circuitry 90, it provides EVENT DETECT OUT information to Trigger Latch 16 via Switch 22. In the single channel arrangement of FIG. 1, the EVENT DETECT OUT signal is used directly as a trigger pulse, indicative of a combination or sequence of anomalies, that can then be used by Acquisition Controller 4 to determine which samples will form an acquired waveform.

Switch 22 selects either the output of Programmable Logic circuit 90 when a user is interested in detecting combinations of anomalies (e.g., glitches and slow rise/fall times that occur only when runt conditions are not present), or the output of Trigger Conditioning circuitry 12. Thus, Programmable Logic circuitry 90 provides the ability to recognize potentially complex combinations of anomalies.

For example, a user might want to trigger on a setup and hold violation, but only after a glitch has just been detected. The present invention allows this combination of anomalous events to be recognized by appropriately programming Programmable Logic circuit 90.

Programmable Logic circuit 90 may comprise any combination of conventional logic elements capable of producing a specific output associated with a predetermined combination or sequence of detected anomalies. Such logic elements may, for example, include one or more AND gates, NAND gates, OR gates, flip-flops, programmable logic devices, such as field programmable gate arrays (FPGAs) and the like, or any other conventional logical operator or operators, as well as any combination thereof. Each predetermined combination or sequence of detected anomalies may be based upon design considerations or test conditions associated with a particular circuit being observed.

In addition, Programmable Logic circuitry 90 may be programmed to operate according to conditional logic rules, such as, an IF, THEN, ELSE statement. For example, Programmable Logic circuitry 90 may be programmed to produce an EVENT DETECT OUT signal if a specified first trigger combination is followed by a second specified trigger combination, and otherwise to look for a third trigger combination.

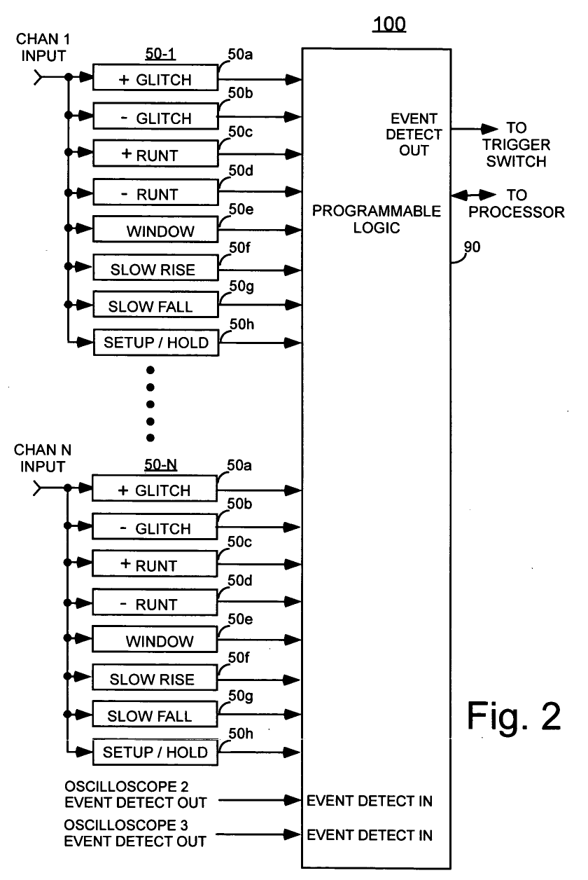

Although FIG. 1 shows application of the invention to a single channel oscilloscope, it is important to note that the invention may also be applied to a multi-channel oscilloscope. In this case, each channel of a multi-channel Oscilloscope 100 may be provided with an array of Anomaly Detectors 50, and a Programmable Logic circuit 90. For example, a four channel Oscilloscope would include a total of four arrays of Anomaly Detectors 50, and a total of four Programmable Logic circuits 90. However, FIG. 2 shows an alternate arrangement for applying the teaching of the subject invention to a multi-channel oscilloscope.

FIG. 2 is a simplified block diagram showing only those portions of FIG. 1 that are required to understand this embodiment of the invention. Each channel of and N-channel Oscilloscope 100 has an associated array of Anomaly detectors 50-1 through 50-N. The output signals of all of these Anomaly Detectors are coupled to respective inputs of a single Programmable Logic circuit 90.

Each channel contains Acquisition System circuitry 8, and Trigger Conditioning and Comparator circuitry 12, as discussed above with respect to FIG. 1. All of the channels share common components (not shown in FIG. 2) such as, a common Switch 22 and a common Trigger Latch 16, which are used by Acquisition Controller 4 of each channel to determine when to stop acquiring data.

By use of the arrangement of FIG. 2, Programmable Logic circuit 90 allows combinations of signals from the various Anomaly Detection circuits from multiple channels to be used to trigger Oscilloscope 100.

For example, a first input channel may be setup, via Programmable Logic circuitry 90, to recognize all anomalies except runts (i.e., disable detectors 50c and 50d of Anomaly Detect array 50-1). A second input channel may be setup to recognize all anomalies except slow rise or fall times (e.g., disable detectors 50f and/or 50g of Anomaly Detector array 50-2 (not shown)). A third channel might be setup to recognize all anomalies (i.e., none of the detectors of anomaly Detector array 50-3 (not shown) are disabled). Programmable Logic circuit 90 would then take into account each of the prescribed conditions for each channel and produce an EVENT DETECT OUT signal only when all of the conditions are satisfied.

Anomaly Detection signals from multiple oscilloscopes (not shown), each having circuitry according to FIGS. 1 and 2, may be combined as shown in FIG. 2. That is, the EVENT DETECT OUT signals produced by Programmable Logic circuits 90 of Oscilloscope 200 or Oscilloscope 300 may be applied to respective Event Detect IN terminals of Programmable Logic circuit 90 of Oscilloscope 100. Programmable Logic circuit 90 of Oscilloscope 100 would then take into account each of the prescribed conditions for each channel of each connected oscilloscope, and produce an EVENT DETECT OUT signal only when all of the conditions on all of the oscilloscopes are satisfied. The single EVENT DETECT OUT signal may be coupled to Oscilloscopes 200 and 300 to trigger them.

Alternatively, one skilled in the art will realize that a multi-conductor cable could be used to apply the output signals of Anomaly Detector arrays 50-1 through 50-N of Oscilloscope 200 or Oscilloscope 300 directly to input terminals of Programmable Logic circuit 90 of Oscilloscope 100. This arrangement would also allow Programmable Logic circuit 90 of Oscilloscope 100 to take into account each of the prescribed conditions for each channel of each connected oscilloscope, and produce a single EVENT DETECT OUT signal only when all of the conditions on all of the oscilloscopes are satisfied. The single EVENT DETECT OUT signal may be coupled to Oscilloscopes 200 and 300 to trigger them.

It will be appreciated that the invention is not restricted to the particular embodiments that have been described, and that variations may be made therein without departing from the scope of the invention as defined in the appended claims and equivalents thereof. For example, the invention is not restricted to use with a digital oscilloscope, and is also applicable to other test and measurement instruments, such as a logic analyzer. One skilled in the art will realize that one or more of detectors 50a-50h may be omitted, and detectors for responding to other anomalous events may be provided in addition to, or in lieu of, one or more of detectors 50a-50h.

While the foregoing is directed to specific embodiments of the present invention, other and further embodiments of the invention may be devised without departing from the basic scope thereof, and the scope thereof is determined by the claims that follow.

1. A test and measurement instrument, comprising:
a trigger system including a trigger circuit for detecting a trigger event associated with an input signal;
a plurality of anomaly detectors, each of said anomaly detectors being responsive to said input signal for detecting occurrences of a predetermined anomalous event in said input signal, and providing an output signal indicative of said detection of said anomalous event; and
a programmable logic circuit, for receiving said output signals of said anomaly detectors, generating a detection signal in response to a predetermined combination or sequence of said signals indicative of said occurrence of said anomalous events, and applying said detection signal to said trigger system.

2. The test and measurement instrument of claim 1, wherein
said test and measurement instrument includes a plurality of channels; and
said plurality of anomaly detectors further comprises:
a second plurality of anomaly detectors, each of said second plurality of anomaly detectors being associated with a second channel of said test and measurement instrument, and being responsive to a second input signal for detecting occurrences of a predetermined anomalous event in said second input signal, and providing an output signal indicative of said detection of said anomalous event; and
said programmable logic circuit receives said output signals of said first and second pluralities of anomaly detectors, generates a trigger signal in response to a predetermined combination or sequence of said signals indicative of said occurrence of said anomalous events in said first or second channels or in both channels, and applies said detection signal to said trigger system.

3. The test and measurement instrument of claims 1 or 2, wherein said detection signal of said programmable logic circuit is coupled to said trigger system such that said detection signal acts as a trigger signal.

4. The test and measurement instrument of claim 2, wherein said programmable logic circuit is programmed to respond to a particular sequence of anomalies wherein each anomaly of said sequence of anomalies occurs on different predefined channel of said plurality of channels.

5. The test and measurement instrument of claim 4, wherein said detection signal of said programmable logic circuit is coupled to said trigger system such that said detection signal acts as a trigger signal.

6. The test and measurement instrument of claim 1, wherein said test and measurement instrument is an oscilloscope.

7. The test and measurement instrument of claim 1, wherein said test and measurement instrument is a logic analyzer.

8. A test and measurement system, comprising:
a first test and measurement instrument including,
a first trigger system including a trigger circuit for detecting a trigger event associated with a first input signal;
a first plurality of anomaly detectors, each of which is associated with a first channel of said first test and measurement instrument, and responsive to said first input signal for detecting occurrences of a predetermined anomalous event in said first input signal, and providing an output signal indicative of said detection of said anomalous event; and
a first programmable logic circuit, for receiving said output signals of said first plurality of anomaly detectors;
a second test and measurement instrument including, a second plurality of anomaly detectors, each of which is associated with a first channel of said second test and measurement instrument, and responsive to a second input signal for detecting occurrences of a predetermined anomalous event in said second input signal, and providing an output signal indicative of said detection of said anomalous event; and
a second programmable logic circuit, for receiving said output signals of said second plurality of anomaly detectors, generating a detection signal in response to a predetermined combination or sequence of said signals indicative of said occurrence of said anomalous events in said second input signal, and applying said second detection signal to said first programmable logic circuit; wherein
said first programmable logic circuit generates a first detection signal in response to a predetermined combination or sequence of said signals indicative of said occurrence of said anomalous events in said first and second input signals, and applying said detection signal to said first trigger system;

9. A test and measurement system, comprising:
a first oscilloscope including,
a first trigger circuit for detecting a trigger event associated with a first input signal;
a first plurality of anomaly detectors, each of which is associated with a first channel of said first oscilloscope, and responsive to said first input signal for detecting occurrences of a predetermined anomalous event in said first input signal, and providing output signals in response thereto; and
a first programmable logic circuit, for receiving said output signals of said first plurality of anomaly detectors;
a second oscilloscope including, a second plurality of anomaly detectors, each of which is associated with a first channel of said second oscilloscope, and responsive to a second input signal for detecting occurrences of a predetermined anomalous event in said second input signal, and providing output signals in response thereto;
wherein
said first programmable logic circuit of said first oscilloscope also receives said output signals of said second plurality of anomaly detectors of said second oscilloscope, generates a detection signal in response to a predetermined combination or sequence of said signals indicative of said occurrence of said anomalous events in said first and second input signals, and applies said detection signal to said first trigger circuit.

10. A method for triggering an oscilloscope, comprising:
receiving an input signal;
simultaneously monitoring said input signal for occurrences of different kinds of anomalies;
detecting occurrences of said different kinds of anomalies in said input signal;
providing output signals indicative of detection of occurrences of each kind of anomalous event
providing a trigger signal to a trigger circuit of said oscilloscope when a predetermined combination or sequence of anomalies is detected.

11. An oscilloscope, comprising:
an input for receiving an input signal;
a monitoring circuit for simultaneously monitoring said input signal for occurrences of different kinds of anomalies;
said monitoring circuit including a plurality of detector circuits for detecting occurrences of said different kinds of anomalies in said input signal, and for providing output signals indicative of detection of occurrences of each kind of anomaly;
a programmable logic circuit responsive to said output signals indicative of said detection of occurrences of said anomalies and to programmed instructions for providing a trigger signal when a predetermined combination or sequence of said anomalies is detected; and
a trigger circuit responsive to said trigger signal for triggering said oscilloscope.
